(19) United States
(12) Patent Application Publication
(10) Pub. No.: US 2015/0242789 A1
(43) Pub. Date: Aug. 27, 2015

(54) PROPENSITY MULTIPLIER FOR CUSTOMER MESSAGE AND OPPORTUNITY MANAGEMENT

(71) Applicant: BANK OF AMERICA CORPORATION, Charlotte, NC (US)

(72) Inventors: Diane S. Cannato, Lake Worth, FL (US); Adam John Burgess, Matthews, NC (US); Timothy Alan Mincey, Belmont, NC (US); Moran Ludwig, Zurich (CH); Murali Mohan Atyam, Charlotte, NC (US); Chris Williams McCaffrey, Arlington, MA (US); Caleb Lee Lam, Charlotte, NC (US); James Richard Kilcoyne, Jr., Montclair, NJ (US)

(73) Assignee: BANK OF AMERICA CORPORATION, Charlotte, NC (US)

(21) Appl. No.: 14/192,507

(22) Filed: Feb. 27, 2014

(51) Int. Cl. G06Q 10/06

(52) U.S. Cl. CPC G06Q 10/06316

(57) ABSTRACT

Embodiments of the invention are directed to a system, method, or computer program product for providing a propensity multiplier for customer message and opportunity management, such that an associate can more effectively assist a customer. The system may provide a customer profile associated with the customer to the channel. The profile compiles customer interaction data, including real-time and batched historic customer interaction data. This data is utilized to predict communication points and opportunities for the customer that may be most relevant to the customer. In this way, the system determines a propensity for each of the communication points and/or opportunities and modifies the ranking of each based on triggers from the received customer interaction data. Thus, providing the communication points and opportunities to an associate within a customer profile, such that the associate is prepared with communication points and opportunities tailored for the customer he/she is interacting with.

### BACKGROUND

Customers typically have a variety of options when communicating with entities such as financial institutions. A customer may have one or more ways he/she prefers to communicate with the financial institution, such as calling the financial institution, online, mobile, automatic teller machine (ATM), or at a brink-and-mortar location. When a customer communicates with a financial institution, the financial institution wants to assist that customer's quickly and effectively.

### BRIEF SUMMARY

Embodiments of the present invention address the above needs and/or achieve other advantages by providing apparatuses (e.g., a system, computer program product and/or other devices) and methods for providing a propensity multiplier for customer message and opportunity management, such that customer communications, both real-time and batch, can be used to personalize or influence future communications to the customer. Thus, an associate of a financial institution can more effectively assist a customer based on recent customer interactions with the entity, irrespective of the communication channel.

A customer may wish to interact with an entity, such as a financial institution. The customer interaction may be for one or more reasons such as to complete a transaction, conduct business, a question, a dispute, review the entity website, request information about the entity's services, or the like. Furthermore, the customer may be able to interact with the entity via several different channels of communication. These may include online or offline communication channels. Online communication channels may include one or more of communications via a website, application, chatting, email, or the like. Offline communication channels may include the customer going to a store location, an ATM, or the like. With several different locations and channels for a customer to communicate with the entity, it is important that the entity can identify why the customer has interacted with the entity, either in the past or in real-time.

In some embodiments, the invention may receive real-time customer interaction data from across all of the channels of the entity. In some embodiments, this may also include receiving data from vendor channels or other channels outside of the entity. The interactions may include completing a transaction with the entity, such as a financial institution. These transactions may include depositing, withdrawing, financial services, credit services or the like. The interactions may also be interactions with an associate, such as at a branch, via a chat, or telephone communications. Furthermore, the interactions may also include reviewing a website or selecting a specific tab on the financial institution's website. Finally, the interactions may also include any interactions with outside vendors, or the like, associated with the financial institution. Once the interactions are received then invention may determine if the interaction is in real-time or is in the past. If the interaction is in the past, the system may batch the interactions for that customer together for the last 5 years.

In some embodiments, this invention takes both batch data relating to prior customer interactions and data associated with real-time customer interactions to provide a propensity multiplier for customer messaging and opportunity management. The propensity multiplier may then analyze the data to either influence a proposed sequence of communications with a customer and/or personalize opportunities to be presented to a customer. Each of the influences sequence of communications and the personalized opportunities may be presented to the appropriate channel within the financial institution via a customer profile associated with that customer.

The invention sorts through the various customer interactions, both real-time and batched, to identify customer interaction triggers. In some embodiments, customer interaction triggers may be utilized to determine if an influence sequence of communications to a customer is required. In this way, an associate of the entity may be provided with an profile for the customer indicating the sequence influence. In other embodiments, customer interaction triggers may be utilized to determine if opportunities presented to the customer need to be personalized. In this way, the modifications to the customer opportunities may be presented to the customer via the interact provide for that customer. Customer interaction triggers are derived from the customer interaction data. The customer interaction triggers are identified as potential customer interactions that lead to one or more influencing or modification of future customer communications. These triggers may be specific transactions, groups of transactions, specific selection from a website, specific telephone inquiries, or the like. The triggers may be programmed by an associate, may be identified based on logic, may be identified based on modeling, and/or identified based on algorithms.

Customer interaction triggers may be utilized to determine if an influence sequence of communication points to a customer is required. In this way, the customer interaction triggers may be identified. The trigger may identify one or more pre-determined communication points to discuss with the customer during his/her next interaction. The pre-determined communication point associated with the trigger may be included in with the other communication points already established for the customer. As such, an algorithm is provided to determine a sequence of those communication points to be presented to the customer. For example, a customer may have had two communication points. These may include discussing talking to a financial advisor about his/her finances and discussing details about mobile banking. Subsequently, the customer may select information about mortgages on the financial institution website. This selection may be a customer interaction trigger that triggers a new communication point of discussing mortgages with the customer. The algorithm may determine that the discussing of mortgages should be the top communication point. As such, the interaction trigger associated with the customer reviewing mortgages on a website triggered an influence of sequences of communication points.

Customer interaction triggers may be utilized to determine if a modification to opportunities presented to the customer need to be made. Modifications may be based on one or more customer interactions that uncover events in a customer's life. Thus the customer interaction triggers allow for more timely and/or relevant opportunity presentment to a customer. The system may identify life events thought the customer interactions. These may be predicted based on logic or an algorithm. For example, a customer may be purchasing several items from a store that sells baby clothing. As such, the identification of these transactions at the financial institution may trigger a customer interaction trigger. This trigger may uncover a life event that the customer is planning on having a child. As such, opportunities may be presented to the customer based on that life event.

In this way, the system may influence a sequence of communications with the customer in the future and/or personalize an opportunity to present to a customer. Therefore, the system may essentially attempt to predict one or more reasons why the customer may attempt to communicate with the entity in the future allows the system to prepare the associates for customer interaction and allows for improved customer service. Predicting one or more reasons why the customer will be communicating with the entity in the future is determined by the customer interaction data from above.

The invention may provide the influenced sequence of communications and/or the personalized opportunity to an associate via a customer profile.

The customer profile may be generated by the real-time processing of the data received and is provided to the channel. In some embodiments, the customer profile may be an interface provided to an associate of the entity. In other embodiments, the customer profile may be incorporated into the channel. For example, a customer profile may incorporate customer specific items onto a customer's mobile or online banking application for the customer to view when he/she logs in.

Embodiments of the invention relate to systems, methods, and computer program products for providing customer message and opportunity management, the invention comprising: receiving real-time customer interaction data, wherein real-time customer interaction data includes real-time information about customer interactions with a financial institution; receiving historic customer interaction data and batch the historic customer interaction data into batched customer interaction data based on similar patterns associated with the historic customer interaction data; identifying, by applying logic to the real-time and the batched customer interaction data received, pre-determined triggers in customer communications; determining, based on the identification of triggers in the real-time and the batched customer interaction data, one or more communication points or customer opportunities derived from triggers identified in the real-time and the batched customer interaction data; ranking and influencing an order of communication points, including the one or more communication points derived from the triggers, based on predicted relevance of the communication point; personalizing a list of customer opportunities, include the one or more customer opportunities derived from triggers, based on a predicted relevance of the customer opportunities; and generating a customer profile, wherein the customer profile illustrates the influenced ranking of communication points to discuss with the customer and the personalized list of customer opportunities to present to the customer.

In some embodiments, the invention further comprises presenting the customer profile to an appropriate communication channel, wherein the appropriate communication channel is the channel the customer is initiating interaction with. The customer profile is adapted to be presented to an associate at a communication channel associated with the financial institution where a communication has been initiated between the customer and the associate, the customer profile provides the associate with immediate access to the influenced ranking of communication points to discuss with the customer and the personalized list of customer opportunities, wherein the customer profile further includes information about recent customer interactions, and accounts the customer has with the financial institution.

In some embodiment, the pre-determined triggers are determined by the financial institution and are key interactions or transaction that a customer performs that triggers a service or promotion that the financial institution predicts the customer to have interest.

In some embodiments, determining one or more communication points or customer opportunities derived from triggers identified in the real-time and the batched customer interaction data further comprises predicting one or more topics of interest for future customer communications based on the customer interaction data.

In some embodiments, determining one or more communication points or customer opportunities derived from triggers identified in the real-time and the batched customer interaction data further comprises compiling the real-time and the batched customer interaction data to determine patterns that correlate to a life event associated with the customer.

In some embodiments, generating the customer profile with the influenced ranking of communication points to discuss with the customer and the personalized list of customer opportunities to present to the customer further comprises inserting variable text via tokens into the profile to generate updates to a template associated with the profile.

In some embodiments, one or more communication points are points of interest that are presented to an associate when a customer is interacting with the associate, wherein the one or more communication points are tailored to the specific real-time and batch interaction data for the customer.

In some embodiments, the one or more customer opportunities are promotions, services, or offers available to the customer based on the specific real-time and batch interaction data for the customer, wherein the one or more customer opportunities are presented to an associate when a customer is interacting with the associate.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating the propensity multiplier for customer message and opportunity management, in accordance with one embodiment of the present invention;

FIG. 2 provides a propensity multiplier system environment, in accordance with one embodiment of the present invention;

FIG. 3 provides a process map illustrating integration of the propensity multiplier with entity customer facing interactive channels, in accordance with one embodiment of the present invention;

FIG. 4 provides a process map illustrating customer interaction data analysis for influencing sequence of customer communications or modification of customer opportunities, in accordance with one embodiment of the present invention;

FIG. 5 provides a process map illustrating the propensity multiplier for influencing communication sequences for a customer, in accordance with one embodiment of the present invention;

FIG. 6 provides a process map illustrating the propensity multiplier for modification of opportunities for a customer, in accordance with one embodiment of the present invention; and

FIG. 7 provides an example interface of a customer profile, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that have customer interactions.

Some portions of this disclosure are written in terms of a financial institution's unique position with respect to customer transactions. As such, a financial institution may be able to utilize its unique position to receive, store, process, retrieve, and present information associated with customer transactions and customer communications.

The embodiments described herein may refer to the term associate. An associate may include one or more individuals associated with an entity that a customer may communicate with. This associate may be a bank teller, a customer service representative, other employee, partner, or the like associated with the entity. Furthermore, a “channel” as used herein may be one or more ways in which a customer may communicate with an entity, such as a financial institution. These channels may include one or more of online or offline channels. Online channels may include applications, clouds, websites, mobile applications, ATMs, or the like. Offline channels may include store locations, drive through locations, or the like.

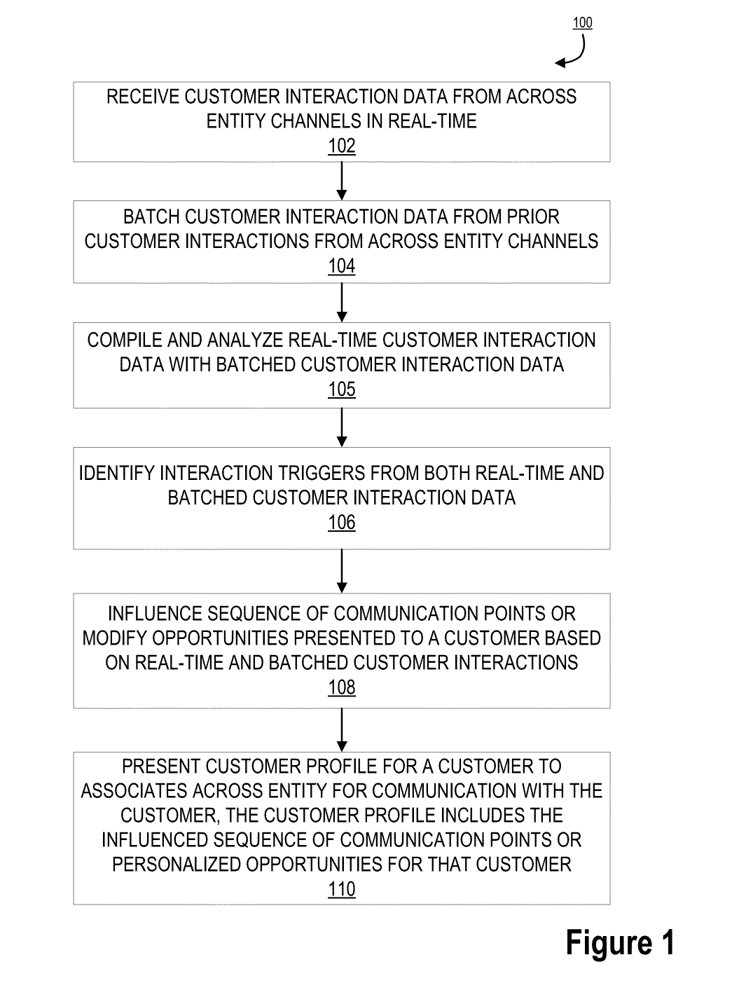

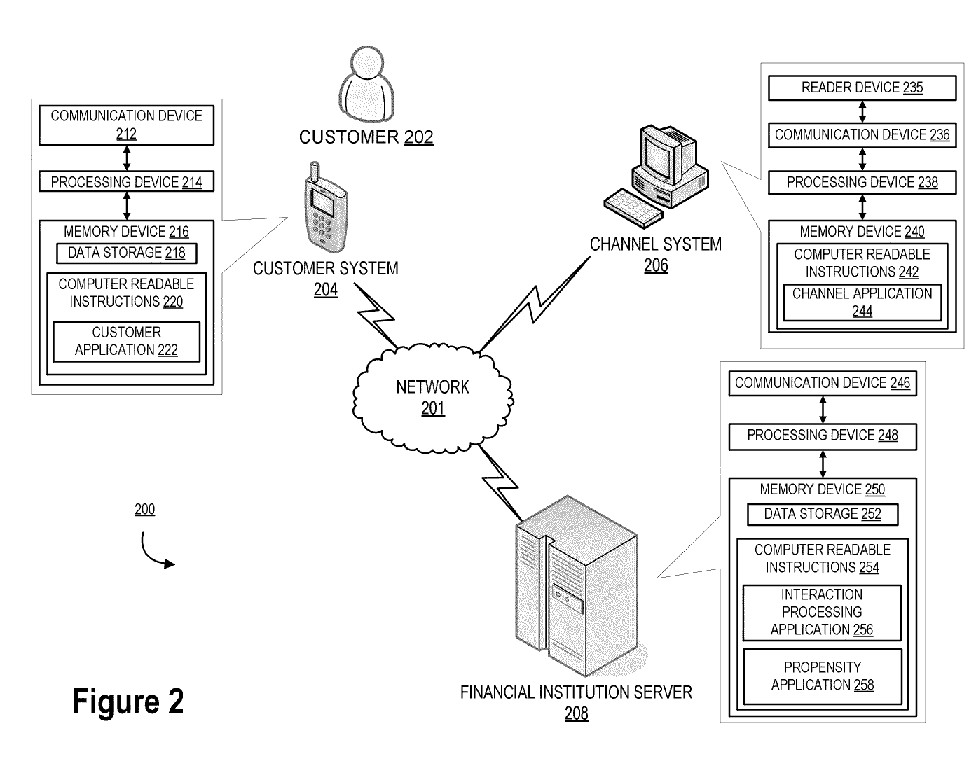

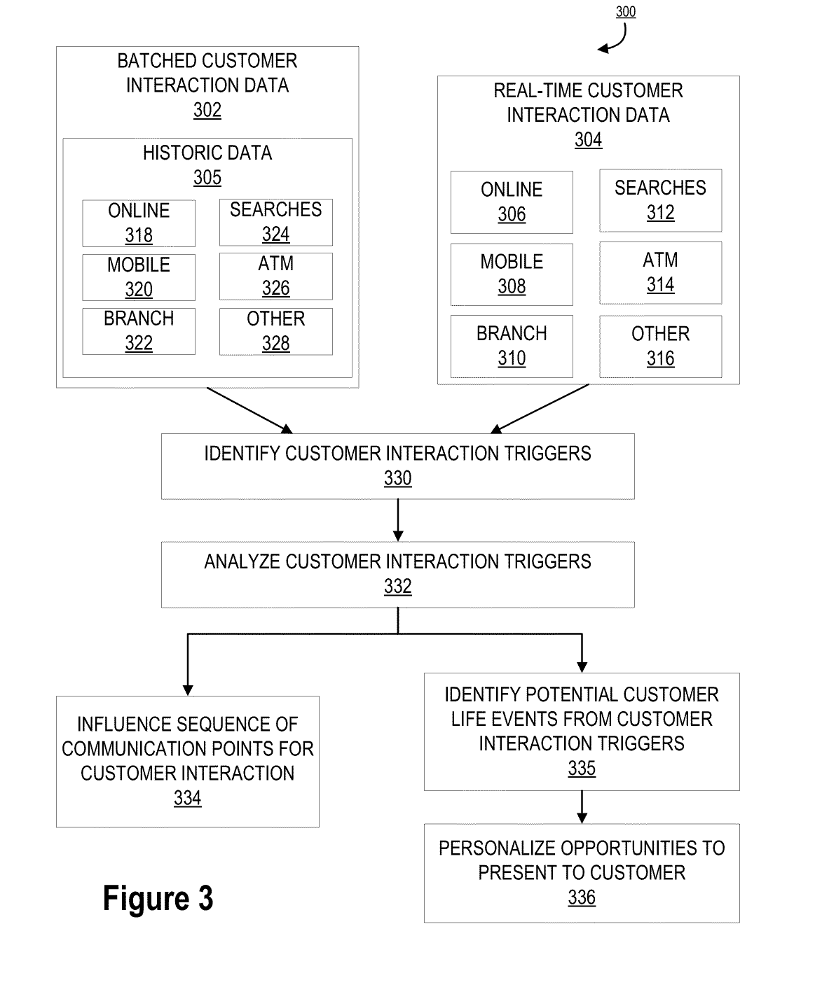

FIG. 1 illustrates a high level process flow for propensity multiplier for customer message and opportunity management 100, in accordance with one embodiment of the present invention, which will be discussed in further detail throughout this specification with respect to FIGS. 2 through 7. The first step in the process 100, as illustrated in block 102, is to receive customer interaction data from across entity channels. This data is received in real-time or close thereto. The customer interaction data may be in the form of customer transactions using entity provided account, customer communications with the entity, or the like. A customer, as used herein may include, but is not limited to, a user, individual, person, entity, or other individual that may do business or have an account with a financial institution. Next, as illustrated in block 104, once the customer interaction data has been received, the system may receive batched customer interaction data from prior customer interactions from across the entity channels. Because customer interaction data includes several different types of data, as illustrated in further detail below with respect to FIG. 3, the context of the data needs to be determined for further analysis. In this way, as illustrated in block 105 the customer interaction data is compiled and analyzed. This includes both the real-time interaction data and the batched customer interaction data.

Next, as illustrated in block 106, the process 100 continues by identifying triggers from both real-time and batched customer interactions. These customer triggers are from the customer interaction data that trigger one or more influencing or modification of future customer communications. These triggers may be programed by an associate, may be identified based on logic, may be identified based on modeling, and/or identified based on algorithms. As illustrated in block 108, if a customer interaction data identifies a trigger, the system may influence a sequence of communications with the customer in the future and/or personalize an opportunity to present to a customer. In some embodiments, the system may influence the sequence of communications for customer communications in the future. In other embodiments, the system may personalize opportunities to present to the customer.

Finally, as illustrated in block 110, a customer profile for a customer is presented to associates across the entity for communication with customers, the customer profile may include the influenced sequence or personalized opportunities to present to a customer during the next customer communication. This presentation may be based on authorization of that channel or associate having access to the specific for that customer.

FIG. 2 provides a propensity multiplier system environment 200, in accordance with one embodiment of the present invention. As illustrated in FIG. 2, the financial institution server 208 is operatively coupled, via a network 201 to the customer system 204, and to the channel system 206. In this way, the financial institution server 208 can send information to and receive information from the customer system 204 and the channel system 206 to receive customer interaction data and provide customer profiles. FIG. 2 illustrates only one example of an embodiment of a propensity multiplier system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual interacting with a financial institution. The interaction may be via one or more channels associated with the financial institution or entity. As such, the interaction may be made at or through a channel system 206 associated with the financial institution. Channels may include one or more branch locations, online websites, mobile applications, online applications, over the phone, at the merchant's place of business, ATM, or other mediums of communication with a financial institution and/or vendors associated with the financial institution.

In some embodiments, the interaction may be made by the customer 202 using a customer system 204, such as a mobile wallet (i.e. smart phone, PDA, and the like) or other types of systems that communicate with other systems on the network 201, such as the channel system 206 and/or financial institution servers 208. In some embodiments of the invention, the customer 202 may interact with the financial institution using his/her customer system 204. In this way, the customer 202 may log on to his/her online or mobile banking application. Furthermore, the customer 202 may enter into transactions using his/her customer system 204, the transaction may be associated with one or more accounts associated with the financial institution. In other embodiments, the customer 202 may interact with a vendor or other entity that may provide interaction data to the financial institution. In some embodiments, the customer 202 may be a merchant or a person, employee, agent, associate, independent contractor, and the like that has an account or business with a financial institution.

FIG. 2 also illustrates a customer system 204. The customer system 204 generally comprises a communication device 212, a processing device 214, and a memory device 216. The customer system 204 is a computing system that allows a customer 202 to interact with the financial institution and enter into transactions both via a network 201. The processing device 214 is operatively coupled to the communication device 212 and the memory device 216. The processing device 214 uses the communication device 212 to communicate with the network 201 and other devices on the network 201, such as, but not limited to the channel system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may provide event data, communicate with the financial institution, receive customer context profiles, and/or be able to enter into transactions using the customer application 222. The customer system 204 may be, for example, a desktop personal computer, a mobile system, such as a cellular phone, smart phone, personal data assistant (PDA), laptop, or the like. Although only a single customer system 204 is depicted in FIG. 2, the propensity multiplier system environment 200 may contain numerous customer systems 204. The customer application 222 allows for

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the channel system 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of an interaction processing application 256 and a propensity application 258. In some embodiments, the memory device 250 includes data storage 252 for storing data related to the customer context communication aid including but not limited to data created and/or used by the interaction processing application 256 and/or the propensity application 258.

In the embodiment illustrated in FIG. 2 and described throughout much of this specification, the interaction processing application 256 received customer interaction data, compiles batch customer interaction data, analyzes both real-time and batch customer interaction data, and identifies interaction triggers associated therewith.

The interaction processing application 256 first receives interaction data for processing via the processing device 248. In some embodiments, the interaction data received is real-time customer interaction data. This real-time customer interaction data includes current interactions a customer 202 is having with the financial institution. The real-time data is collected across the entire entity, irrespective of the channel the interaction is taking place on. The interaction processing application 256 receives various types of customer interaction data from across the entity to process and determine if modification of opportunities and/or sequence of communication influencing needs to occur. As such, data may be received from one or more systems on the network 201, such as, but not limited to the customer system 204 and the channel system 206. In some embodiment, data includes data about a customer 202 online activity associated with a financial institution, which may include traditional online data and/or inquiry data. Online data includes information about a customer's online or mobile activity. Specifically, online date may include whenever a customer 202 accesses his/her online or mobile banking application or portal. Each time a customer 202 accesses his/her online banking portal the system may identify the items viewed, requested, selected, or the like on the customer's portal. As such, this data may be provided to the interaction processing application 256 and stored as interaction data associated with the customer 202 in the memory device 250. Customer interaction data may also include inquiry data. Inquiry data includes any inquiry a customer 202 makes to the financial institution and/or entities associated therewith, irrespective of the channel the customer 202 is making the inquiry. As such, if a customer 202 inquires about opening a savings account, a mortgage, checking account, credit card, or other inquire with respect to products or services associated with the financial institution. Furthermore, inquires may also include simply clicking on a tab or cursing over a link on a financial institution associated website.

In some embodiments, interaction data received by the interaction processing application 256 includes transaction data. Transactional data may be received by the financial institution if the customer 202 utilizes an account associated with the financial institution for the transaction. As such, when a customer 202 utilizes a financial institution account for a transaction the interaction processing application 256 may receive information about the transaction and process that information into interaction data to be used to personalize opportunities and/or influence communication sequences.

In some embodiments, the interaction processing application 256 compiles batch customer interaction data. Batch customer interaction data includes any or all customer interaction data over the last 5 years. In this way, the interaction processing application 256 may batch together interactions a customer 202 may have had with the entity over the last 5 years. This data may be utilized to determine patterns, life events, or the like associated with the customer 202.

In some embodiments, the interaction processing application 256 processes and analyzes the real-time and batched customer interaction data received. In some embodiments, this is done in real-time as the customer interaction is occurring at the financial institution. The analyzing occurs via the processing device 248 and take into account all of the various customer interaction data received, including real-time and batched data.

In some embodiments, the interaction processing application 256 may identify interaction triggers associated with the real-time and batched customer interaction data received. The customer interaction triggers are utilized by the propensity application 258 to determine if an influence sequence of communications to a customer is required. In other embodiments, the customer interaction triggers may be utilized by the propensity application 258 to determine if opportunities presented to the customer need to be personalized. Customer interaction triggers which are identified by the interaction processing application 256 are derived from the customer interaction data. Customer interactions are identified as triggers based on the probability that the one or more customer interactions identified will lead to one or more influencing or modification of future customer communications. These triggers may be specific transactions, groups of transactions, specific selection from a website, specific telephone inquiries, or the like. The specific triggers may be identified via logic, rules, algorithms, and intelligence to identify triggers from the customer interaction data. As such, some portions of the system include the ability to identify and/or learn triggers that may predict what the customer 202 will be wishing to discuss during his/her next communication and/or what opportunities the customer 202 may be most interested in. As such, a probability tool is incorporated based on modeling and prior experiences into the interaction processing application 256.

In the embodiment illustrated in FIG. 2 and described throughout much of this specification, the propensity application 258 utilizes the identified interaction triggers associated with the customer interaction data to prepare for future customer interactions, identifies sequence communications which are to be influenced, identifies opportunities to modify, and presents the influenced communication sequence and personalized opportunities updates to the customer profile for that customer.

In some embodiments, the propensity application 258 may take the identified interaction triggers and prepare for future customer interactions. In this way, the propensity application 258 may determine if modifications to opportunities and/or changes in sequence of communications to a customer 202 may be required. The preparation requires the propensity application 258 to apply logic, rules, algorithms, and intelligence to identify if the triggers from the customer interaction data cause a modification to opportunities and/or a change in sequence of communications to a customer 202. As such, some portions of the system include the ability to learn the resulting outcome of triggers to predict what the customer 202 will be wishing to discuss during his/her next communication and/or what opportunities the customer 202 may be most interested in. As such, a probability tool is incorporated based on modeling and prior experiences into the propensity application 258. In some embodiments, the propensity application 258 may create a table that identifies specific trigger/opportunity instructions for a specific trigger. Furthermore, triggers may be grouped into classifications to further identify if one or more sequences or opportunities need to be personalized.

The propensity application 258 will look for trends based on logic and/or rules in customer 202 communications such that it may provide insight into what future communications the customer 202 may make. In this way, the propensity application 258 may identify sequence communications to be influence and identify opportunities to be personalized. Thus, the propensity application 258 may, utilizing tokens, provide instructions to execute propensity or template identification changes in a customer profile for a customer 202.

In some embodiments, the propensity application 258 may identify sequence communications which are to be influenced. In this way, the propensity application 258 may receive interaction triggers identified by the interaction processing application 256 and utilize them to determine if an influence sequence of communications to a customer 202 is required. In this way, the propensity application 258 may identify one or more new communication points to bring up during the next customer 202 communication with the financial institution. A communication point may be one topics that an associate may bring up with a customer 202 based on one or more interaction triggers. Once the propensity application 258 identifies and creates a communication point, a score or logic may be attributed to the communication point utilizing a logic based algorithm. The propensity application 258 then compares the score to previously established communication points for the customer 202 to determine if a sequence influence is warranted. If such a sequence change of communication points is determined to be necessary, the propensity application 258 may utilize tokens to provide instructions to execute template changes in the customer profile for that customer 202.

In this way, the propensity application 258 provides an ordered list of communication points for the next time the customer 202 interacts with the financial institution. As such, the scoring performed by the propensity application 258 may aid in predicting one or more reasons why the customer 202 may attempt to communicate with the entity in the future. This allows the propensity application 258 to prepare the communication channel for customer 202 interaction and allows for improved customer service.

In some embodiments, the communication points provided by the propensity application 258 may also include one or more points regarding life changes or life events associated with the customer 202. As such, the propensity application 258 may also predict life events that are based on the customer interaction data that may be included as one or more communication points an associate may discuss with the customer 202 next time the customer 202 is in communication with the entity. These communication points may be based on the customer's interaction with the entity or these talking points may be based on predicted life events. The predicted life events are determined based on transactions and other interactions the customer 202 has made recently using financial institution accounts. For example, a customer 202 may have purchased a lot of home improvement products lately and may have also applied for a mortgage. As such, the next time the customer 202 communicates with an associate, the associate can discuss the home improvement projects and/or the customer's new home purchase.

In some embodiments, the propensity application 258 may identify opportunities to present and/or personalize for a customer 202. In this way, the propensity application 258 may receive interaction triggers identified by the interaction processing application 256 and utilize them to determine to present and/or personalize opportunities to present to the customer 202. In this way, the propensity application 258 may identify one or more new opportunities to bring up during the next customer 202 communication with the financial institution. Opportunities may include one or more services, discounts, promotions, offers, coupons, or the like that the customer 202 may be interested in based on his/her interaction data. If an opportunity is determined to be personalized and/or newly presented to a customer 202, the propensity application 258 may utilize tokens to provide instructions to execute template changes in the customer profile for a customer 202. In this way, the propensity application 258 provides an ordered list of opportunities the next time the customer 202 interacts with the financial institution.

In some embodiments, modifications may be based on one or more customer interactions that uncover events in a customer's life. Thus the customer interaction triggers allow for more timely and/or relevant opportunity presentment to a customer 202. The propensity application 258 may identify life events thought the customer interactions. These may be predicted based on logic or an algorithm. The predicted life events are determined based on transactions and other interactions the customer 202 has made recently using financial institution accounts. For example, a customer may be purchasing several items from a store that sells baby clothing. As such, the identification of these transactions at the financial institution may trigger a customer interaction trigger. This trigger may uncover a life event that the customer is planning on having a child. As such, opportunities may be presented to the customer 202 based on that life event.

In some embodiments customer event data received by the propensity application 258 includes external data. External data may be extracted from one or more other entities or other information provided by the customer 202. External data may also aid the propensity application 258 in determining an indication as to a life event associated with the customer 202. This way, the external data of the customer 202 may be used to provide opportunities to the customer 202 and aid in predicting the next communication the customer 202 may make with the financial institution.

In this way, the propensity application 258 may influence a sequence of communications with the customer 202 in the future and/or personalize an opportunity to present to a customer 202. Therefore, the propensity application 258 in combination with the interaction processing application 256 may essentially attempt to predict one or more reasons why the customer 202 may attempt to communicate with the entity in the future allows the propensity application 258 to prepare the associates for customer interaction and allows for improved customer service.

Finally, the propensity application 258 presents the influenced communication sequence and/or the personalized opportunities updates to the customer profile for the customer 202. In some embodiments, the propensity application 258 may generate the customer profile for the customer 202. In other embodiments, the propensity application 258 may provide an updated the customer profile for the customer 202 to the channels as a communication aid. In this way, the propensity application 258 may create one or more tokens to provide instructions to execute template changes in the customer profile.

In this way, the propensity application 258 may provide a customer profile for each customer 202. The customer profile may be an interface provided to an associate of the entity. In other embodiments, the customer profile may be incorporated into the channel. For example, a customer profile may incorporate customer specific items onto a customer's mobile or online banking application for the customer to view when he/she logs in.

As illustrated in FIG. 2, the channel system 206 is associated with the channel that the customer 202 is interacting with. As such, the customer 202 may be able to interact or communicate with the entity via several different means or channels. These may include online or offline channels. Online interactions may include one or more of communications via a website, application, chatting, email, or the like that may occur over a network 201. Offline channels may include the customer going to a store location, an ATM, or the like. The channel system 206 generally comprises a reading device 235, a communication device 236, a processing device 238, and a memory device 240. The reading device 235 is operatively coupled to the processing device 238, communication device 236, and the memory device 240. The channel system 206 may include a reader device 235 to receive authentication of customer 202 access to his/her accounts at the financial institution. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment account and/or transaction data at the channel system 206 and communicates the information via the communication device 236 over a network 201, to other systems such as, but not limited to the financial institution server 208 and/or the customer system 204. As such, the communication device 236 generally comprises a modem, server, or other device for communicating with other devices on the network 201.

As further illustrated in FIG. 2, the channel system 206 comprises computer-readable instructions 242 stored in the memory device 240, which in one embodiment includes the computer-readable instructions 242 of a channel application 244.

In the embodiment illustrated in FIG. 2, the channel application 244 allows the channel system 206 to be linked to the financial institution server 208 and customer system 204 to communicate, via a network 201, the information related to the customer profile, such as customer 202 data, previous customer 202 communications, personalized opportunities, sequenced communication or talking points, and the like. Furthermore, the channel application 244 may identify a customer 202 when he/she enters a location associated with a financial institution. In some embodiments the channel application 244 may identify a customer 202 by customer authorization at the reader device 235. In some embodiments, the channel application 244 may identify the customer 202 based on associate or customer 202 input. In yet other embodiments, the channel application 244 may identify the customer 202 as being a pre-determined distance away from the branch location. This may be done via geo-fencing or geo-locating of the customer 202 via the customer system 204 being within the geo-fencing range.

In this way, the channel application 244 may identify that an interaction has been initiated between the customer 202 and the financial institution channel. Furthermore, the channel application 244 may store information associated with the date, time, channel, disposition, and the like associated with the interaction in the memory device 240.

The channel system 206 may also, upon identifying the customer 202 is initiating an interaction at the channel associated with that channel system 206 may receive and present, via the communication device 236 the customer profile for the customer 202 from the financial institution server 208. Thus, the customer profile may provide the channel with the personalized opportunities to present to the customer 202, the influenced communication sequence to present to the customer 202 in the appropriate order, and/or a general communication aid based on customer interaction data, such that the communication channel can or effectively assist a customer 202.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 illustrates a process map providing integration of the propensity multiplier with entity customer facing interactive channels 300, in accordance with one embodiment of the present invention. Customer interaction data may be received by the interaction processing application 256. The interaction processing application 256 may process the received data and subsequently, along with the propensity application 258 determine if an influence to a sequence of communications and/or a modification of opportunities for a customer 202 may be required. The customer interaction data may be included from 19 or more data sources from within the entity and/or from vendors or the like associated with the entity. The interaction data collected may be in the form of batched customer interaction data 302 and/or real-time customer interaction data 304.

Batched customer interaction data 302 may be customer interaction data batched together based on type, transaction, trigger, location, date, predicted life event, or the like. The batched customer interaction data 302 may be batched from the last 5 years of customer 202 interactions with the financial institution. As such, the batched customer interaction data 302 is historic data, as illustrated in block 305. Batched customer interaction data 302 may come from many sources, the categories of sources for batched customer interaction data 302 includes from online sources 318, mobile sources 320, interactions with branches 322, customer searches 324, ATM interactions 326, or other interactions 328 with the financial institution or vendors associated therewith.

In some embodiments, the interaction data collected may be in the form of real-time customer interaction data 304. Real-time customer interaction data 304 may be up to the minute data about customer 202 interactions with the financial institution. Real-time customer interaction data 304 may come from many sources, the categories of sources for real-time customer interaction data 304 includes from online sources 306, mobile sources 308, interactions with branches 310, customer searches 312, ATM interactions 314, or other interactions 316 with the financial institution or vendors associated therewith.

Online source data 318, 306 includes information about a customer's online activity. Specifically, online date may include whenever a customer 202 accesses his/her online banking application or portal. Upon accessing the customer's online banking application, the system may determine what the customer 202 may have viewed while on his/her online banking application, selected tabs, links, or the like. For example, a customer 202 may log into an online banking website by entering a username and a password. Subsequently the customer 202 may manage his/her accounts on the online banking website. As such, the customer 202 may transfer funds, view balances, apply for credit, or the like. Each time a customer 202 accesses his/her online banking portal the system may identify the items viewed, requested, selected, or the like on the customer's portal. As such, this data may be provided to the system and stored as batched customer interaction data 302 associated with the customer 202.

Mobile source data 320, 308 includes information about a customer's mobile financial institution activity. Specifically, mobile date may include whenever a customer 202 accesses his/her mobile banking application or portal via a mobile device. Upon accessing the customer's mobile banking application, the system may determine what the customer 202 may have viewed while on his/her mobile banking application, selected tabs, links, or the like. For example, a customer 202 may log into an mobile banking website by entering a username and a password. Subsequently the customer 202 may manage his/her accounts on the mobile banking website. As such, the customer 202 may transfer funds, view balances, apply for credit, or the like. Each time a customer 202 accesses his/her mobile banking portal the system may identify the items viewed, requested, selected, or the like on the customer's portal. As such, this data may be provided to the system and stored as batched customer interaction data 302 associated with the customer 202.

Branch source data 322, 310 includes information about a customer's interaction with associates at a financial institution branch. Specifically, branch source data 322 may include information whenever a customer 202 enters a branch to complete a transaction and/or inquiry regarding services provided by the financial institution.

Search source data 324, 312 includes data from any financial institution channel that may search or inquiry by a customer 202. Search source data includes any inquiry a customer 202 makes to the financial institution, irrespective of the channel the customer 202 is making the inquiry. As such, if a customer 202 inquires about opening a savings account, a mortgage, checking account, credit card, or other inquire with respect to products or services associated with the financial institution. As such, if the customer 202 goes online and requests a product or service, goes to a branch location and inquires about a product or service, goes to an ATM to inquire about a product or service, or the like, the system may receive the inquiry data and process the data to be used to update the customer's context profile and aid in predicting the next communication the customer 202 may make with the financial institution.

ATM source data 326, 314 includes transactions and the like that a customer 202 may complete at an ATM. These may include any payment, deposit, withdrawal, or other transaction potentially available via an ATM.

Other source data 328, 316 includes data from vendors or other channels within the financial institution not described above. Other source data may include transactions that a customer 202 may make with a financial institution account at a vendor or the like. Transactional data may be received by the financial institution if the customer 202 utilizes an account associated with the financial institution for the transaction. For example, a customer 202 may purchase Product 1 at Merchant A. The transaction may be completed by the customer 202 using his/her credit card that was provided to the customer 202 from the financial institution. As such, the financial institution may receive transaction data for processing that includes a transaction at Merchant A for Product 1. As such, when a customer 202 utilizes a financial institution account for a transaction the system may receive information about the transaction and process that information into event data to be used to update the customer profile and aid in predicting the next communication the customer 202 may make with the financial institution. Other source data may also include information about a customer 202 identified at a financial institution, such as account opening information, addresses, or the like.

Utilizing the batched customer interaction data 302 and real-time customer interaction data 304, the system may identify customer interaction triggers, as illustrated in block 330. Identifying interaction triggers associated with the real-time and batched customer interaction data received are used to determine if an influence sequence of communications and/or modification of opportunities for a customer is required. Customer interactions are identified as triggers based on the probability that the one or more customer interactions identified will lead to one or more influencing or modification of future customer communications. These triggers may be specific transactions, groups of transactions, specific selection from a website, specific telephone inquiries, or the like. The specific triggers may be identified via logic, rules, algorithms, and intelligence to identify triggers from the customer interaction data.

Next, as illustrated in block 332 the system may analyze the customer interaction triggers. This analysis aids in determining if modifications to opportunities and/or changes in sequence of communications to a customer 202 may be required. Logic, rules, algorithms, and intelligence may be applied to identify if the triggers from the customer interaction data cause a modification to opportunities and/or a change in sequence of communications to a customer 202. As such, some portions of the system include the ability to learn the resulting outcome of triggers to predict what the customer 202 will be wishing to discuss during his/her next communication and/or what opportunities the customer 202 may be most interested in. In some embodiments, a table may be provided that identifies specific trigger/opportunity instructions for a specific trigger. Analysis of customer interaction triggers also includes examining the triggers for trends in the data that it may provide insight into what future communications the customer 202 may make.

The analysis of customer interaction triggers in block 332 may determine if the sequence of communications is to be influence, as illustrated in block 334 and/or if a modification of opportunities presented to a customer may be needed, as illustrated in block 336.

In some embodiments, the analysis of customer interaction triggers in block 332 may influence the sequence of communications provided to the customer, as illustrated in block 334. In this way, the system may determine one or more communication points derived from the customer interaction triggers. Once the communication point is created based on the customer interaction triggers the system may determine if the communication point is more or less important to the customer 202. If it is important, the system may identify that the communication point is relevant to the customer 202, then the sequence of communication points presented to the customer may be manipulated to provide that particular communication point in front of other available communication points.

In some embodiments, the analysis of customer interaction triggers in block 332 may lead to a modification of opportunities presented to a customer 202. These opportunities may be based on customer 202 interaction. In this way, if a customer 202 was reviewing the financial institution website for mortgage information, the system may identify this as an interaction trigger and present the customer 202 with various opportunities related to mortgage services. In some embodiments, the personalized opportunities may also be based on an identification of potential life events associated with customer interaction triggers. As such, various transactions or other interactions may clue the system into life events that the customer 202 may be currently involved in, such as mile marker events, like birthdays, having children, going to school, anniversaries, or the like.

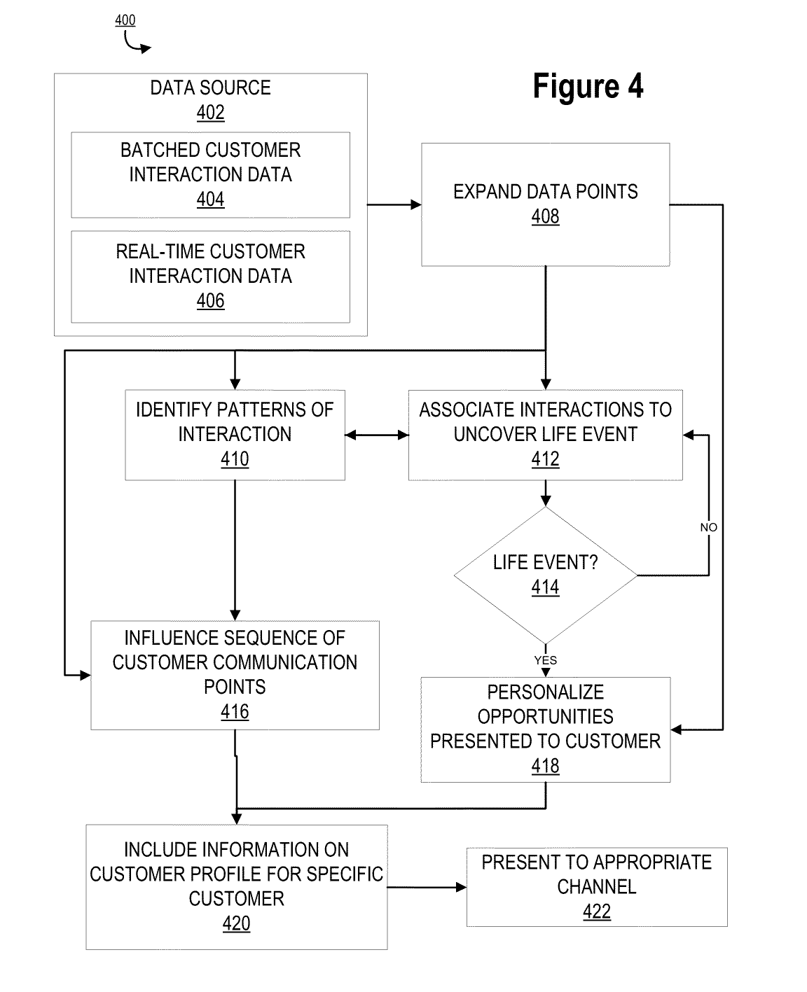

FIG. 4 illustrates a process map for customer interaction data analysis for influencing sequence of customer communications or modification of customer opportunities 400, in accordance with one embodiment of the present invention. As illustrated in block 402, the process 400 is initiated when the system receives data source information. As further detailed above with respect to FIG. 3, the data sources 402 may include batched customer interaction data 404 and/or real-time customer interaction data 406.

Next, as illustrated in block 408, the process 400 continues by expanding the data points associated with the interaction data. As such, the system may determine patterns, sequences, connections, or the like associated with the customer interaction data. In this way, the system may be able to potentially identify all triggers associated with customer 202 transactions such that the entity may provide better customer service by providing updated sequences of communication points for an associate to discuss with a customer 202 next time he/she communicates with the entity and/or a modification of opportunities presented to the customer 202. If the expanded data points provide data enough to initiate an interaction trigger, the data may be used to influence the sequence of customer communication points, as illustrated in block 416 and/or personalize opportunities presented to the customer, as illustrated in block 418.

However, if the data points do not initiate an interaction trigger the process 400 may continue to identify patterns of the interactions, as illustrated in block 410. If patterns are identified as providing an interaction trigger, then the sequence of customer communication points may be influences, as illustrated in block 416.

Referring back to block 408, if the data points do not initiate an interaction trigger the process 400 may continue to further associate interactions to potentially uncover life events, as illustrated in block 412. Next, as illustrated in decision block 414, it is determined if a life event has been identified. If no life event has been identified, the process 400 reverts back to block 412. If a life event has been identified in decision block 414 the process 400 may continue to personalize opportunities that may be presented to the customer, as illustrated in block 418.

Next, as illustrated in block 420 the customer profile associated with the customer 202 may be changed to include the influenced sequence of customer communication points and/or the personalized opportunities. Finally, as illustrated in block 422 the customer profile for the customer 202 is presented to the appropriate channel.

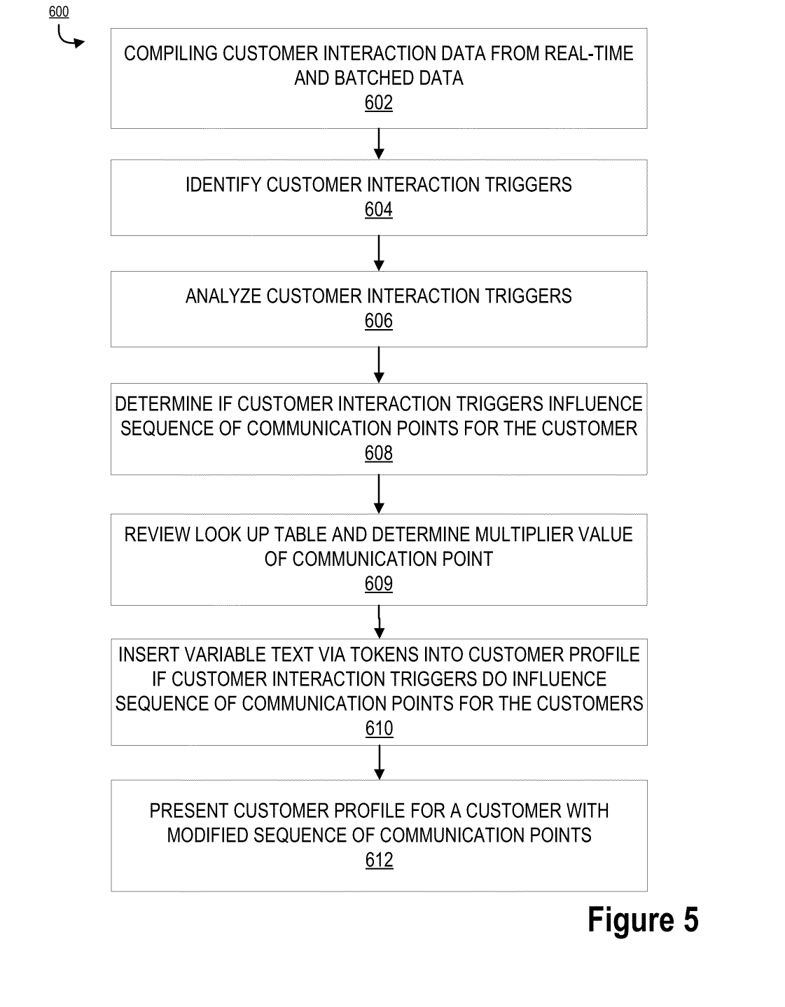

FIG. 5 illustrates a process map providing the propensity multiplier for influencing communication sequences for a customer 600, in accordance with one embodiment of the present invention. As illustrated in block 602, the process 600 is initiated by compiling customer interaction data from both real-time and batched data. Next, customer interaction triggers are identified, as illustrated in block 604. The customer interaction triggers are then analyzed, as illustrated in block 606.

Next, as illustrated in block 608, the process 600 continues to determine if the customer interaction triggers may influence sequence of communication points for a customer 202. In this way, there may currently be one or more communication points already available on the customer profile for that customer 202. If one of the customer interaction triggers correlates to a communication point that may be presented to the customer 202, the communication point is ranked in order of importance along with the other communication points available. As discussed in detail above, there is logic built into the system to rank and categorize each of the current and new communication points for the customer profile.

Next, as illustrated in block 609, the process 600 continues to review a look up table and determine the multiplier value of an identified communication point. The look up table reviews the communication point and ensure that multiple triggers don't update the sequence of communication points multiple times. This way, the process 600 ensures better predictability of communication points of interest to the customer 202. The multiplier value may be one or more weighted scores applied to the communication point derived from the customer interaction data that determines the importance of the communication point. In this way, the multiplier value may weigh the newly determined communication point against pre-established communication points for that customer 202. If the new communication point has a greater value, the system may influence the communication point sequence by sequencing the communication point with the greater value above the others.

If it has been determined that customer interaction triggers do influence the current sequence of communication points for a customer 202, the process 600 continues to insert variable text via tokens into the customer profile if the customer interaction triggers do influence the sequence of communication points, as illustrated in block 610. In this way, a template associated with the customer's profile may be varied to create a unique customer profile using the customer interaction data.

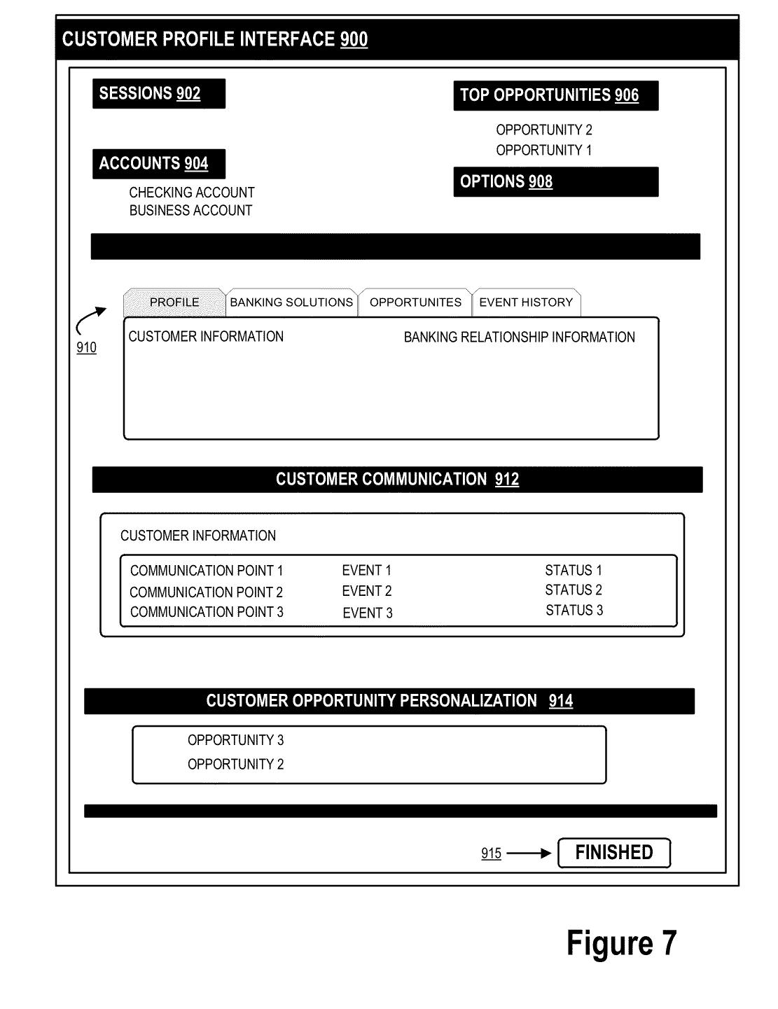

Finally, as illustrated in block 612, the inserted variable text is inputted into a customer profile and the customer profile is presented with the personalized sequence of communication points. In this way, the customer profile may have one or more newly modified communication points for an associate to review. The associate may then initiate communications with a customer 202 utilizing the customer profile associated with the customer 202 and thus have one or more modified communication points to discuss with the customer 202. In this way, the associate may be prepared with communication points to discuss with the customer 202 that are based on customer interactions. An associate and/or the channel itself, may be presented with the customer profile to aid in communications with the customer 202. As illustrated below in FIG. 7, a customer profile is illustrated with communication points presented.

FIG. 7 illustrates an example of a customer profile interface 900, in accordance with one embodiment of the present invention. As illustrated on the customer profile interface 900 that is presented to an associate prior to or at initiation of the customer 202 communication.

Once the customer profile for that particular customer is received at the channel, the received customer profiles are stored at the channel. Subsequently, the customer 202 may enter the channel to communicate with the financial institution. The customer 202 may be identified when he/she enters the communication channel. In some embodiments the communication channel may be via the customer's online or mobile banking application. As such, the customer 202 may log into his/her online or mobile banking. The log in of the customer 202 triggers the customer profile for that customer 202. As such, the system identifies the customer 202 based on the customer's authentication and logging into his/her online or mobile banking. In some embodiments, the communication channel the customer 202 may communicate with the financial institution may include an ATM or the like. In this way, the customer 202 may have to provide a credit or debit card to the ATM and provide a personal identification number (PIN) associated therewith. Providing the credit or debit card and the PIN associated therewith triggers presentment of the customer profile for that customer 202. In some embodiments, the customer 202 may communicate with the financial institution by physically going to the financial institution branch. In this way, when the customer 202 enters the branch, the system may identify the customer 202 either by an agent speaking with the customer 202, customer authorization via credit or debit card, PIN authorization, or the like.

Once the system has identified the customer when he/she enters the communication channel, the system may retrieve the customer profile for the particular customer 202 at the channel. The customer profile may be stored at the financial institution server 208 or the channel system 206. In this way, the channel may have quick access to the one or more customer profiles necessary for each customer 202 as that customer 202 initiates communication with the financial institution. Next the retrieved customer profile is then presented to the communication channel. In some embodiments, the customer profile is presented to an associate of the entity at the communication channel. In some embodiments, the customer profile or information therefrom is incorporated into an interface viewed by the customer 202, such as the online or mobile application, online banking website, or the like.

Next the associate and/or channel may review the customer profile to identify the sequence of communication points and/or the opportunities for the customer 202 communicating at that channel. In this way, the system may present recent customer 202 communications and outcomes to the associate for review immediately prior to the customer 202 communication with that associate or channel. Upon reviewing the customer profile to determine the reason for the customer 202 communication the associate or channel may greet the customer 202 at the communication channel based a communication point. The communication point may have been triggered based on customer interaction data of the customer 202. The communication point may be presented via the customer profile such that the associate may immediately view and discuss the communication points with the customer 202.

Referring back to FIG. 7, at section 902 the sessions associated with that customer 202 are presented. There may be one or more sessions the customer 202 may have had within the last day/week/month. This section 902 also allows the associate to search the sessions and communications that a customer 202 has had previously. Next, as illustrated in section 904, the accounts the customer 202 has with the financial institution are displayed. These accounts may include one or more checking accounts, savings accounts, credit cards, loans, mortgages, lines of credit, or the like.

Section 906 provides the associate with the top opportunities the customer 202 may have, in order. These top opportunities include Opportunity 2 and Opportunity 1. However, as illustrated in section 914 the customer opportunity modification has been triggered based on the interaction trigger. In this way, the opportunities, are now Opportunity 2 and Opportunity 2 based on the interaction triggers that were identified and personalized based on the identified interaction triggers from both real-time and batched customer interaction data.

Finally, section 908 illustrates an options category, allowing for various options with respect to the customer interact interface 900. These options include agent verification, commitment, opening a new account, refreshing a profile, providing maintenance, setting future appointments for the customer 202, sales tools, general tools, inquiry tools, opportunities management, and recent customer options.

As further illustrated in FIG. 9, section 910 of the customer profile interface 900 includes the interface's main screen functions and tabs. These include viewing the customer profile, banking solutions for the customer, opportunities for the customer, and event history for the customer 202. The customer 202 profile section may include customer 202 information, such as the title, address, and other contact information associated with the customer 202. This profile also includes bank relationship information such as how long the customer 202 has been a bank customer, the party identification, relationship manager, total balances, accounts, and/or other information that the customer 202 may have in affiliations with the financial institution. Banking solutions include any solutions that the system has developed based on past customer communications or transactions. For example, a solution may stem from a recent telephone call the customer 202 made to a call center. An associate may follow up with solutions for that prior call to the call center. Opportunities will link back to the opportunities and promotions that the financial institution may have available for the customer 202. Finally, the event history tab provides a quick view of the most recent events of the customer 202. These events may include any events that are added as customer event data. The event history tab may also disclose the time, date, disposition, and the like associated with the one or more recent events for the customer 202.

Next, as illustrated in section 912, the customer profile interface 900 includes a pop up indicator with customer communications. The pop up customer communications section comprises a quick view of the important customer 202 information on the customer profile interface 900. This customer communication section 912 includes customer information, customer events, and whether action is required based on a triggering interaction.

As illustrated in section 912, there may be a communication points that the associate may start the communication with the customer 202. These communication point may be presented directly to the associate via the customer profile interface 900 such that the associate may initiate the customer 202 communication with the communication point. Finally, when the communication is complete, the agent may select the finish button 915 to exit out of the customer profile interface 900.

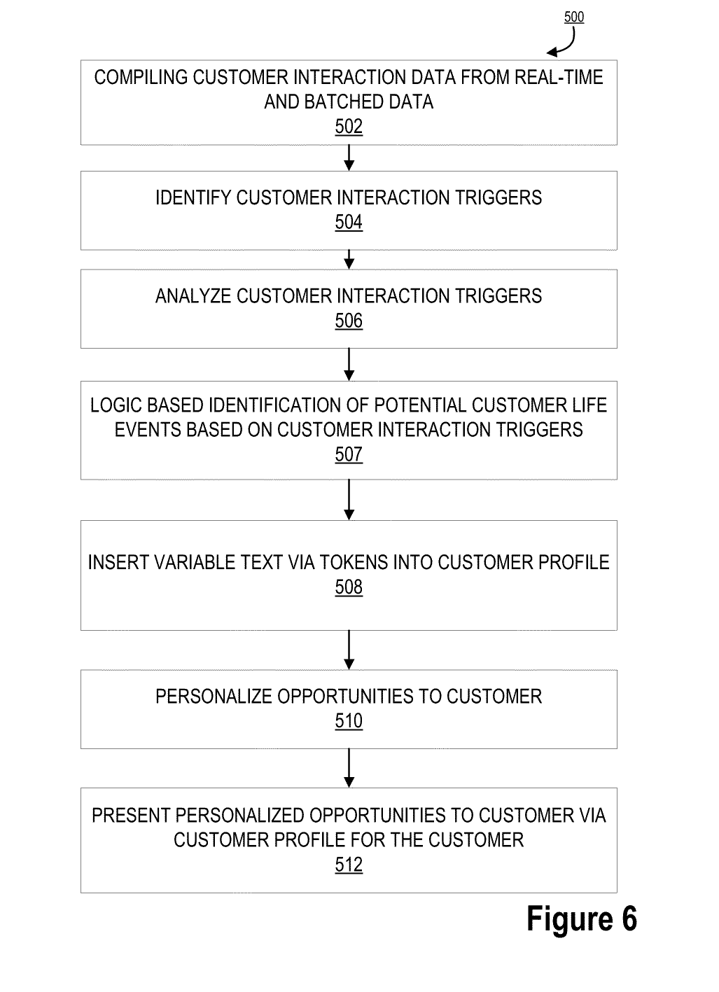

FIG. 6 provides a process map illustrating the propensity multiplier for modification of opportunities for a customer 500, in accordance with one embodiment of the present invention. As illustrated in block 502, the process 500 is initiated by compiling customer interaction data from both real-time and batched data. Next, customer interaction triggers are identified, as illustrated in block 504. The customer interaction triggers are then analyzed, as illustrated in block 506.

As illustrated in block 507, the process 500 continues to provide logic based identification of potential customer life events based on the customer interaction triggers. Next, as illustrated in block 508, variable text may be inserted into the customer profile based on either the customer life events and/or the customer interact triggers. Thus, personalizing the opportunities presented to the customer 202, as illustrated in block 510.

Finally, the personalized opportunities are presented to a customer 202 via the customer profile for that customer 202 as further illustrated in FIG. 7.

In some embodiments, the invention may recommend a more appropriate channel for future communications based on the customer interaction triggers as an opportunity to the customer 202. As such, the customer 202 may do one or more transactions via a specific channel, such as going to a branch location to complete a financial transaction. The next time the customer 202 goes to the branch location, the customer profile may allow the teller to present the customer 202 with another channel that may be more convenient for that customer 202 to complete the transaction, such a completing the transaction via mobile banking application or the like. As such, the system may determine patterns of customer communication based on the channel the customer typically utilized for a transaction. The system may then identify one or more other channels that are available to the customer 202 that may be more appropriate or expedite the customer's transaction.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing customer message and opportunity management, the system comprising:
a memory device with computer-readable program code stored thereon;
a communication device;
a processing device operatively coupled to the memory device and the communication device, wherein the processing device is configured to execute the computer-readable program code to:
receive real-time customer interaction data, wherein real-time customer interaction data includes real-time information about customer interactions with a financial institution;
receive historic customer interaction data and batch the historic customer interaction data into batched customer interaction data based on similar patterns associated with the historic customer interaction data;
identify, by applying logic to the real-time and the batched customer interaction data received, pre-determined triggers in customer communications;
determine, based on the identification of triggers in the real-time and the batched customer interaction data, one or more communication points or customer opportunities derived from triggers identified in the real-time and the batched customer interaction data;
rank and influence an order of communication points, including the one or more communication points derived from the triggers, based on predicted relevance of the communication point;
personalize a list of customer opportunities, include the one or more customer opportunities derived from triggers, based on a predicted relevance of the customer opportunities; and
generate, via a computer processing device, a customer profile, wherein the customer profile illustrates the influenced ranking of communication points to discuss with the customer and the personalized list of customer opportunities to present to the customer.

2. The system of claim 1, further comprising presenting the customer profile to an appropriate communication channel, wherein the appropriate communication channel is the channel the customer is initiating interaction with.

3. The system of claim 2, wherein the customer profile is adapted to be presented to an associate at a communication channel associated with the financial institution where a communication has been initiated between the customer and the associate, the customer profile provides the associate with immediate access to the influenced ranking of communication points to discuss with the customer and the personalized list of customer opportunities, wherein the customer profile further includes information about recent customer interactions, and accounts the customer has with the financial institution.

4. The system of claim 1, wherein pre-determined triggers are determined by the financial institution and are key interactions or transaction that a customer performs that triggers a service or promotion that the financial institution predicts the customer to have interest.

5. The system of claim 1, wherein determining one or more communication points or customer opportunities derived from triggers identified in the real-time and the batched customer interaction data further comprises predicting one or more topics of interest for future customer communications based on the customer interaction data.

6. The system of claim 1, wherein determining one or more communication points or customer opportunities derived from triggers identified in the real-time and the batched customer interaction data further comprises compiling the real-time and the batched customer interaction data to determine patterns that correlate to a life event associated with the customer.

7. The system of claim 1, wherein generating the customer profile with the influenced ranking of communication points to discuss with the customer and the personalized list of customer opportunities to present to the customer further comprises inserting variable text via tokens into the customer profile to generate updates to a template associated with the customer profile.

8. The system of claim 1, wherein one or more communication points are points of interest that are presented to an associate when a customer is interacting with the associate, wherein the one or more communication points are tailored to the specific real-time and batch interaction data for the customer.

9. The system of claim 1, wherein one or more customer opportunities are promotions, services, or offers available to the customer based on the specific real-time and batch interaction data for the customer, wherein the one or more customer opportunities are presented to an associate when a customer is interacting with the associate.

10. A computer program product for providing customer message and opportunity management, the computer program product comprising at least one non-transitory computer-readable medium having computer-readable program code portions embodied therein, the computer-readable program code portions comprising:
an executable portion configured for receiving real-time customer interaction data, wherein real-time customer interaction data includes real-time information about customer interactions with a financial institution;
an executable portion configured for receiving historic customer interaction data and batch the historic customer interaction data into batched customer interaction data based on similar patterns associated with the historic customer interaction data;
an executable portion configured for identifying, by applying logic to the real-time and the batched customer interaction data received, pre-determined triggers in customer communications;
an executable portion configured for determining, based on the identification of triggers in the real-time and the batched customer interaction data, one or more communication points or customer opportunities derived from triggers identified in the real-time and the batched customer interaction data;
an executable portion configured for ranking and influencing an order of communication points, including the one or more communication points derived from the triggers, based on predicted relevance of the communication point;
an executable portion configured for personalizing a list of customer opportunities, include the one or more customer opportunities derived from triggers, based on a predicted relevance of the customer opportunities; and
an executable portion configured for generating a customer profile, wherein the customer profile illustrates the influenced ranking of communication points to discuss with the customer and the personalized list of customer opportunities to present to the customer.

11. The computer program product of claim 10, further comprising an executable portion configured for presenting the customer profile to an appropriate communication channel, wherein the appropriate communication channel is the channel the customer is initiating interaction with.

12. The computer program product of claim 11, wherein the customer profile is adapted to be presented to an associate at a communication channel associated with the financial institution where a communication has been initiated between the customer and the associate, the customer profile provides the associate with immediate access to the influenced ranking of communication points to discuss with the customer and the personalized list of customer opportunities, wherein the customer profile further includes information about recent customer interactions, and accounts the customer has with the financial institution.

13. The computer program product of claim 10, wherein pre-determined triggers are determined by the financial institution and are key interactions or transaction that a customer performs that triggers a service or promotion that the financial institution predicts the customer to have interest.

14. The computer program product of claim 10, wherein determining one or more communication points or customer opportunities derived from triggers identified in the real-time and the batched customer interaction data further comprises compiling the real-time and the batched customer interaction data to determine patterns that correlate to a life event associated with the customer.

15. The computer program product of claim 10, wherein generating the customer profile with the influenced ranking of communication points to discuss with the customer and the personalized list of customer opportunities to present to the customer further comprises inserting variable text via tokens into the customer profile to generate updates to a template associated with the customer profile.

16. The computer program product of claim 10, wherein one or more communication points are points of interest that are presented to an associate when a customer is interacting with the associate, wherein the one or more communication points are tailored to the specific real-time and batch interaction data for the customer.

17. The computer program product of claim 10, wherein one or more customer opportunities are promotions, services, or offers available to the customer based on the specific real-time and batch interaction data for the customer, wherein the one or more customer opportunities are presented to an associate when a customer is interacting with the associate.

18. A computer-implemented method for providing customer message and opportunity management, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving real-time customer interaction data, wherein real-time customer interaction data includes real-time information about customer interactions with a financial institution;
receiving historic customer interaction data and batch the historic customer interaction data into batched customer interaction data based on similar patterns associated with the historic customer interaction data;
identifying, by applying logic to the real-time and the batched customer interaction data received, pre-determined triggers in customer communications;
determining, based on the identification of triggers in the real-time and the batched customer interaction data, one or more communication points or customer opportunities derived from triggers identified in the real-time and the batched customer interaction data;
ranking and influencing an order of communication points, including the one or more communication points derived from the triggers, based on predicted relevance of the communication point;
personalizing a list of customer opportunities, include the one or more customer opportunities derived from triggers, based on a predicted relevance of the customer opportunities; and
generating, via a computer processing device, a customer profile, wherein the customer profile illustrates the influenced ranking of communication points to discuss with the customer and the personalized list of customer opportunities to present to the customer.

19. The computer-implemented method of claim 18 wherein determining one or more communication points or customer opportunities derived from triggers identified in the real-time and the batched customer interaction data further comprises predicting one or more topics of interest for future customer communications based on the customer interaction data.

20. The computer-implemented method of claim 18, wherein determining one or more communication points or customer opportunities derived from triggers identified in the real-time and the batched customer interaction data further comprises compiling the real-time and the batched customer interaction data to determine patterns that correlate to a life event associated with the customer.

21. The computer-implemented method of claim 18, wherein generating the customer profile with the influenced ranking of communication points to discuss with the customer and the personalized list of customer opportunities to present to the customer further comprises inserting variable text via tokens into the customer profile to generate updates to a template associated with the customer profile.

22. The computer-implemented method of claim 18, wherein one or more communication points are points of interest that are presented to an associate when a customer is interacting with the associate, wherein the one or more communication points are tailored to the specific real-time and batch interaction data for the customer.

23. The computer-implemented method of claim 18, wherein one or more customer opportunities are promotions, services, or offers available to the customer based on the specific real-time and batch interaction data for the customer, wherein the one or more customer opportunities are presented to an associate when a customer is interacting with the associate.
